(19) United States
(12) Patent Application Publication
(10) Pub. No.: US 2004/0175218 A1
(43) Pub. Date: Sep. 9, 2004

(54) Method and apparatus for printing on flat and non-flat objects

(76) Inventor: Lawrence John Katzer, Kensington, CA (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/728,263

(22) Filed: Dec. 3, 2003

Related U.S. Application Data
(60) Provisional application No. 60/452,595, filed on Mar. 5, 2003.

(51) Int. Cl. B41J 5/30

(52) U.S. Cl. 400/61

(57) ABSTRACT

A method and system for printing graphics, text, logos, or other photographic or digital images (collectively, a “picture”) on a flat or non-flat surface. The surface may be spherical, oblate, cylindrical, flat, or a combination of different curves or shapes. Similarly, the photographic or digital image may be of a variety of computer-readable file formats. The embodiment may employ ultraviolet inks to print the picture on the surface. A variety of pictures and surfaces may be combined to create nearly unlimited products.

### CROSS-REFERENCE TO RELATED APPLICATIONS

This application claims priority to U.S. provisional patent application serial No. 60/452,595, entitled “SYSTEM FOR PRINTING ON FLAT AND NON-FLAT SPORTS RELATED OBJECTS AND OTHER OBJECTS” and filed on Mar. 5, 2003, the entirety of which is incorporated herein by reference.

### BACKGROUND OF THE INVENTION

1. Technical Field

The invention relates generally to methods and systems for printing on flat and non-flat objects, and more specifically to printing an image, logo, or text with ultraviolet inks on a surface.

2. Background Art

Traditionally, text, logos, graphics, and other images are printed on flat and non-flat surfaces through a screen printing process. The screen printing process generally utilizes multiple printing passes, with one color printed during each pass. Screen printing is well known in the art, and has been in existence for some time. Screen printing may, for example, be used to print images on sports-related objects or other objects, such as hockey pucks, baseballs, footballs, bats, other sports equipment, bottles, and so forth.

Unfortunately, screen printing suffers from several drawbacks in its current state. Screen printing is generally time-consuming, requiring a relatively long time to print a single image. Screen printing is also expensive, requiring a large outlay to set up a printing process or apparatus. Screen printing may also require relatively long lead times to produce printed objects or surfaces, since graphic artists are usually required to create the screen, and also is typically limited in the resolution and quality of a printed image.

Another alternative often used is pad printing. Pad printing suffers from many of the previously-enumerated problems. For example, graphic artists are again generally required to create the image used to make the pad (or to create the pad itself). Pad printing is also relatively labor-intensive; a new pad must be made both for each image and color to be printed, and these pads often must be swapped out or changed during the printing process. Further, pad printing generally requires large volume printing runs, due to the aforementioned set-up and labor requirements.

Similarly, most current printing techniques use solvent inks. Although solvent inks at least partially dry relatively quickly, they may require a significantly longer time to completely cure.

Accordingly, an improved method for printing on flat and non-flat surfaces is required.

### SUMMARY

Generally, the invention is a method and system for printing graphics, text, logos, or other photographic or digital images (collectively, a “picture”) on a flat or non-flat surface. The surface, for example, may be spherical (such as a baseball), oblate (such as a football), cylindrical (for example, a hockey puck), flat (such as a cardboard sheet), or a combination of different curves (for example, a bottle). Similarly, the photographic or digital image may be of a variety of file formats, such as a joint photographic experts group (“JPEG”) image, a bitmap, a graphics interchange format (“GIF”) image, a tagged image file format (“TIFF”) image, a portable network graphics (“PNG”) format, or any other computer-readable file format. The embodiment may employ ultraviolet inks to print the picture on the surface. A variety of pictures and surfaces may be combined to create nearly unlimited products.

One exemplary method for printing on a surface includes the operations of providing a digital picture, providing at least one ultraviolet ink, depositing the ultraviolet ink on the surface to form a printed picture corresponding to the digital picture, and curing the ultraviolet ink. The method may further include the operations of segmenting the digital picture into at least a first and second segment, transmitting the first segment to a first print head, transmitting the second segment to the second print head, by means of the first print head, depositing the ultraviolet ink on the surface to form a first printed segment corresponding to the first segment, and by means of the second print head, depositing the ultraviolet ink on the surface to form a second printed segment corresponding to the second segment.

Further embodiments and advantages of the present invention will be readily apparent when reading the detailed description of the invention, below.

### BRIEF DESCRIPTION OF THE FIGURES

FIG. 1 depicts a left side view of a printing machine, in accordance with a first embodiment of the present invention.

FIG. 2 depicts a front view of the printing machine of FIG. 1.

FIG. 3 depicts a segmented picture, in accordance with the first embodiment of the present invention.

FIG. 4 depicts a right side view of the printing machine of FIG. 1.

FIG. 5 depicts an isometric view of the printing machine of FIG. 1.

FIG. 6 is a flowchart detailing the operation of the first embodiment of the present invention.

FIG. 7 is a software data flow diagram, detailing the input and output processes of the first embodiment of the present invention.

### DETAILED DESCRIPTION OF THE INVENTION

Generally, one embodiment of the present invention takes the form of an apparatus for printing graphics, text, logos, or other photographic or digital images (collectively, a “picture”) on a flat or non-flat surface. The surface, for example, may be spherical (such as a baseball), oblate (such as a football), cylindrical (for example, a hockey puck), flat (such as a cardboard sheet), or a combination of different curves (for example, a bottle). Similarly, the photographic or digital image may be of a variety of file formats, such as a joint photographic experts group (“JPEG”) image, a bitmap, a graphics interchange format (“GIF”) image, a tagged image file format (“TIFF”) image, a portable network graphics (“PNG”) format, or any other computer-readable file format. The embodiment may employ ultraviolet inks to print the picture on the surface. A variety of pictures and surfaces may be combined to create nearly unlimited products.

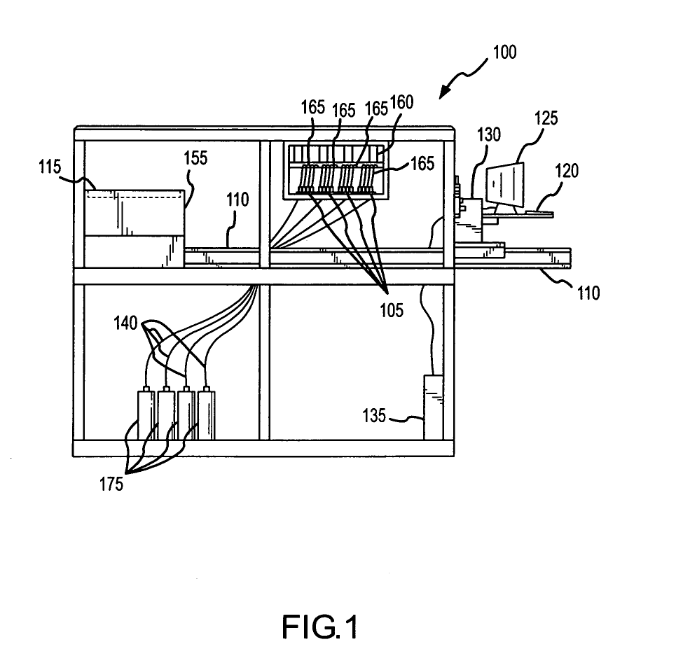

The present embodiment may, for example, take the form of a printing machine 100, as shown in various views in FIGS. 1-2 and 4-5. The printing machine may include one or more print heads 105, a conveyor 110 (such as the illustrated rail, a conveyor belt, series of interlinked holders or depressions, and so forth), curing chamber 115, input device 120, output device 125, ink reservoirs (not shown), and so forth. Typically, a holder is movably affixed to the conveyor, and includes a depression, hole, or other cavity formed therein to accept the surface on which the picture is to be inked by the embodiment. When activated, the holder and associated surface generally move along the rail and beneath the print heads, which print the selected picture. This process is discussed in more detail below. In the present embodiment, sixteen print heads 105 are divided into four groups of four print heads each. Each group of print heads 105 typically prints a different color ink. Alternate embodiments may use more or fewer print heads, more or fewer print head groups, or may not group print heads 105 at all.

The printing machine 100 may accept a ball, puck, flat object, football, or other surface in a holder 130 mounted on the conveyor/rail 110. Generally, the holder 130 may be configured to support the surface and minimize jiggling, disturbances, or other undesired motion acting on the surface. Such motion may cause a blurred image due to inks being deposited on incorrect portions of the surface. This motion may affect the registration of the image and component inks. Generally, “registration” refers to the deposit of differently-colored inks on the same portion of a surface, for example to create a third color resulting from a composite of inks. When registration varies from ink to ink, overlapping individual colors may be seen, and the desired color may be smaller than intended or offset on the surface.

In some embodiments, the holder 130 may include adjustable settings varying the holder size in order to accommodate differently-sized surfaces, while still minimizing the aforementioned undesired motion.

Additionally, it should be noted that the surface is placed in the holder 130 in such a manner as to ensure the surface passes completely beneath each print head 105 without bumping, jarring, or snagging on a print head. Accordingly, the surface is offset from the base of the print heads 105 by a print gap. The print gap may be defined, for example, by placing a weight, rod, or measuring item atop the surface to firmly engage the surface in the holder and measure from a fixed point approximating the bottom of a print head or supporting structure, thus ensuring the necessary clearance. In the present embodiment, the print gap is approximately one millimeter to 6.4 millimeters, or approximately 0.04 inches to 0.25 inches. Such a print gap ensures the surface (whether flat or curved) clears the print heads.

The input device 120 may take a variety of forms, such as a computer keyboard, mouse, optical pointer, microphone, or other device capable of accepting information. Similarly, the output device 125 may be a computer monitor, printer, plotter, or other device capable of displaying information. The input device may accept operator commands, while the output device depicts options from among which the operator may select. For example, the output device 125 may display a variety of digitized pictures, enabling the operator to select one to be printed on the surface. The operator may use the input device 120 to select the picture and optionally begin the printing process.

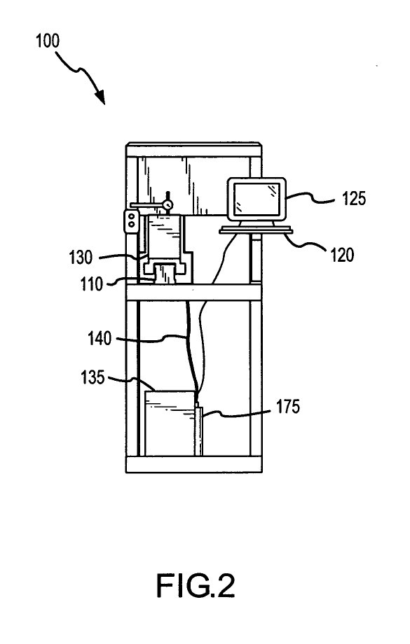

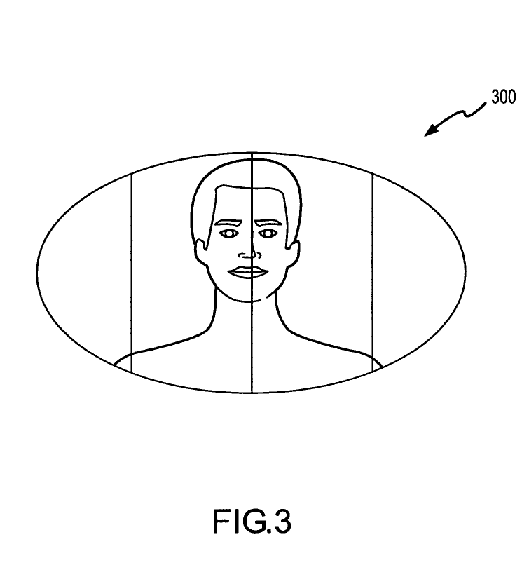

The input 120 and output 125 devices are generally connected to a processor or computer (colloquially, “processor”) 135, shown in FIGS. 1 and 2. In the present embodiment, the processor is located beneath the conveyor 110 and printing heads 105. In alternate embodiments, the processor may be located elsewhere. Generally, the processor controls the printing process. The processor 135, for example, segments a selected, digitized image, transmits each image segment to an appropriate print head, controls the timing of the print heads' firing, moves the holder and surface along the conveyor, and so forth. A segmented picture 300 is shown in FIG. 3. In the present embodiment, the processor 135 is an IBM-PC compatible computer running a Linux operating system. Alternate processors and/or operating systems may be employed by alternate embodiments. For example, alternate embodiments may employ a MACINTOSH or SUN processor, may use alternate operating systems such as any of the MICROSOFT WINDOWS products or UNIX, and so forth. The processor (or associated hardware) may be electronically connected to one or more head interface boards 160, which in turn may be connected to one or more print heads 105. The processor may control the operation of the print heads through the head interface boards 160. A print interface board (not shown) may facilitate such control and operation, as described in more detail below.

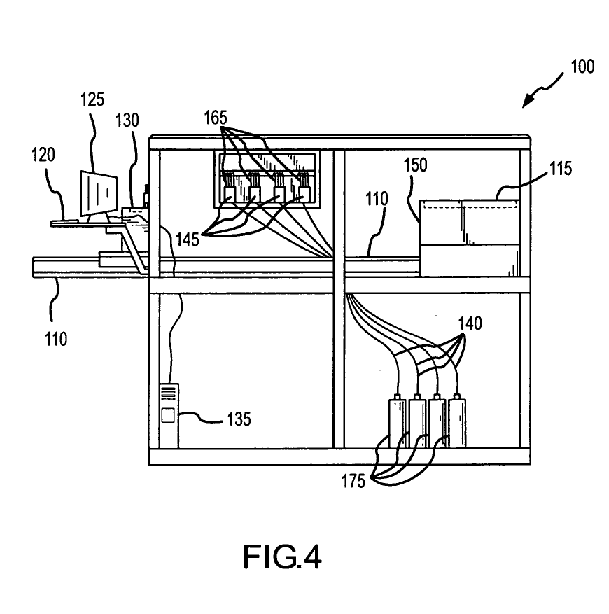

Once the surface is secured within the holder 130 and the print gap defined, the printing process may begin. The holder 130 moves along the length of the conveyor 110 (for example, sliding along a rail or being carried along a conveyor belt), passing beneath each of the print heads 105 in turn. In the present embodiment, as shown in FIG. 4, there are four print heads. It should be noted that the holder 130 and related surface continuously move along the conveyor/rail 110, and do not pause beneath any print head 105 for any appreciable amount of time. In alternate embodiments, the surface and holder may pause in the aforementioned fashion.

As the holder 130 and held surface pass beneath a print head 105, the print head deposits ultraviolet ink on the surface to form at least a portion of the selected picture. In the present embodiment, a media sensor (not shown) is mounted next to the conveyor 110, in proximity to a print head 105. Typically, each group of print heads 105 is associated with a unique media sensor, although alternate embodiments may associate multiple groups of print heads, or a single print head, with a single sensor. The media sensor includes an emitter and a receiver. The emitter emits a light beam, while the receiver receives the beam. As the holder and/or surface breaks the light beam, the media sensor transmits a signal to the associated print head(s) 105, instructing the print head to fire the appropriate ink. In short, the media sensor detects the presence of the surface and coordinates the firing of the associated print head to ensure the ink is properly deposited on the surface to form at least a portion of the picture. Alternate embodiments may omit the media sensors.

Since different surfaces may be differently configured (for example, curved or oblate), the delay between the media sensor detecting the surface and the firing of the print head 105 may be altered by the user. By altering the delay, the positioning of the ink on the surface may be varied to change the position of the picture relative to the surface, effectively offsetting the picture along the longitudinal axis of the conveyor. For example, a user may specify a smaller than normal delay, causing the picture to be printed earlier. Presume, for example, that the positioning of the picture in FIG. 3 corresponds to a “normal” delay. By specifying a smaller delay, the picture would be printed to the left of the picture shown in FIG. 3, presuming a surface travels from the right side of FIG. 3 to the left side. Conversely, specifying a larger delay would cause more of the surface to pass beneath the print head, and the picture would be printed to the right of the picture shown in FIG. 3.

Additionally, each media sensor may instruct individual nozzles making up each print head 105 to fire individually. Thus, the ink deposited by each nozzle may be individually controlled, resulting in different positioning of portions of the picture on the surface.

As previously mentioned, the embodiment generally divides the picture into different longitudinal segments, such that each print head 105 prints only a portion of the overall picture. In the present embodiment, each print head deposits ultraviolet ink to form an adjacent segment of the picture. Generally speaking, in the present embodiment, the picture is divided to form four longitudinal segments, such that each print head 105 prints the picture segment to the right of the previous print head. Thus, in a complete pass under all the print heads, the entirety of the picture is printed. Alternative embodiments may employ more or fewer print heads 105, and thus segment the picture into more or fewer sections.

Returning to FIG. 4, it should also be noted that a picture may be printed from a variety of colored inks, and the embodiment may be configured to deposit ink only of a specific color on a given pass. In other words, multiple passes of a surface beneath the print heads 105 may be employed, with each pass printing the picture in a different color in order to complete the final picture and display all colors. Alternately, the print heads may be configured to deposit multiple colors of inks in a single pass, thus permitting one-pass printing of a picture. Generally, the embodiment may be configured to print a picture in any number of passes desired. In yet another embodiment, print heads 105 may not print on every pass, but may selectively print portions of a picture only on certain passes. In still another embodiment, each pass may offset the printing process by one or more pixels or increments to produce a darker or clearer image.

At the end of a pass, the holder 130 and surface may be retracted along the conveyor 110 to begin the next pass. In some embodiments, the print heads 105 may print only during an extension of the holder along the conveyor, while in other embodiments, the print heads may print during both extension and retraction of the holder. As used herein, “extension” and “retraction” are relative terms; “extension” generally refers to the travel of holder 130 and surface along the conveyor 110 from an initial starting point, while “retraction” refers to the opposite motion. Accordingly, even in embodiments where the holder is fixed relative to the conveyor (such as, for example, in a conveyor belt embodiment), the holder may still “extend” along the length of the conveyor.

Generally, the print heads 105 used to deposit ink on the surface may be of any type known to those skilled in the art. In the present embodiment, the print heads are of a type typically used for plotters, for example print heads manufactured by XAAR or SPECTRA. Although these print heads 105 are typically used in a variety of application, such as printing large-scale text or pictures (for example, billboards) or bar-coding, they may be advantageously adapted for small-scale, close-range printing employing relatively small print gaps.

Each group of print heads 105 may also be angularly offset from the longitudinal axes of either the conveyor 110 or surface. (For reference, the longitudinal axis of the conveyor and the longitudinal axis of the print surface are typically at right angles to one another.) In the present embodiment, the print heads are offset by approximately forty-five degrees from either of the aforementioned longitudinal axes. This angular offset increases resolution of the final picture by narrowing the width (or other appropriate dimension) of the section printed by each print head 105. Because the width narrows, relatively more pixels or droplets of ink may be placed within the section by the print head. The angular offset of the print heads 105 may be varied from embodiment to embodiment, and in some embodiments may be manually changed. As used herein, the term “pixel” generally refers to the image formed by on a surface a single ink droplet emitted from a print head.

The print heads 105 may be primed prior to beginning the printing process. As shown in FIG. 4, the print heads are typically connected by one or more ink tubes 165 to a manifold (not shown), which in turn connects to an ink reservoir 145. Generally speaking, each print head has one ink tube running to a dedicated reservoir for each color ink used in printing the picture. In alternative embodiments, a single ink reservoir 145 per print head for each color ink may be used, or a single tube 165 may connect to multiple ink reservoirs with a switching or shutoff mechanism controlling flow through the single tube from the various reservoirs. Generally, ultraviolet inks do not dry or cake within the tubes 165 and cause clogs. Accordingly, the tubes may contain ink both during the printing process and while the embodiment is inactive.

The reservoirs 145, in turn, typically connect to ink bottles 175 containing an ink supply larger than may be stored in the reservoirs. Each reservoir 145 is typically dedicated to a specific color, and is connected in turn to the appropriate bottle 175 by a feeder tube 140. Alternate embodiments may connect a single reservoir 145 to multiple ink bottles 175, thus permitting the color stored in a reservoir (and printed by the associated print heads 105) to be changed.

The ink reservoirs 145 are shown to best effect in FIG. 4. Generally, the reservoirs are constructed from a plastic, metal, or other suitable material. Each reservoir is typically connected to a pump (not shown) to feed ink along the aforementioned tube 165, through the manifold, and to the print head 105. The pumps may be of any type known to those skilled in the art.

The print heads 105 connected to each reservoir 145 may be either manually or electronically primed. A manual primer may be provided to permit an operator to induce ink flow from the reservoirs 145 to the print head. Additionally, the processor may electronically prime the print heads through one or more pumps connected to the reservoirs and ink tubes 140.

As previously mentioned, the present embodiment generally employs ultraviolet (UV) inks during the printing process. Ultraviolet inks may come in a variety of colors.

In one embodiment, no white UV ink is used. Accordingly, the portion of the surface on which a picture is printed is typically white. This permits the embodiment to print everywhere on the surface, leaving the white surface exposed at places corresponding to white sections of the picture. Generally, ultraviolet inks create a picture of quality equal to that created by more traditional printing processes employing solvent inks, such as pad printing. In the present embodiment, four ink colors are used, namely black, cyan, magenta, and yellow. Other colors may be created by appropriately combining these four inks. Further, picture quality may be improved by using more than four colors of inks. In some embodiments, light cyan and light magenta inks may be used in addition to those enumerated above. Yet other embodiments may employ inks of differing colors.

Typically, the present embodiment employs process colors, rather than so-called spot colors. That is, colors are created by mixing multiple inks (if necessary) to create the desired color, without requiring each ink mixture to strictly adhere to specific chromatic values. In other words, colors may be approximated, rather than strictly conforming to certain hues or chrominances.

In the present embodiment, the image quality of the picture may be adjusted through use of the input device 120, output device 125, and related processor 135. The operator may choose to vary the number of dots per inch (DPI) printed by the print heads 105, thus changing the picture resolution.

When printing on a curved surface, the print gap between the outer edges of a printed picture and the print head may be greater than the print gap between the middle of the picture and the print head 105, due to the curvature of the surface. This same curvature may cause the edges of the picture to appear blurred, fuzzy, or otherwise indistinct, since the expanded print gap results in greater distance between points of ink deposited by the print heads. Essentially, because the print heads 105 deposit ink to form a flat picture and do not take surface curvature into account, as the flat picture is mapped to the curved surface the distance between inks increases.

Accordingly, the embodiment may be configured to print within a colored circle or border around the edges of the picture. The exact configuration and color of the border may be chosen by the operator, may be dependent on the shape of the picture, or may be a combination of both (for example, the operator may be presented a limited number of border shapes dependent on the picture shape). By bordering the picture, any distortion, feathering, or other fuzziness around the picture edges may be minimized and a smooth, continuous, neat appearance created. Typically, such borders are pre-printed on the surface, and the picture formed inside the border. In alternate embodiments, the borders may be printed with the picture.

Alternately, the distance between ink dots placed on a surface (i.e., “pixels”) may gradually be increased at the edges of the picture to create a “feathering” effect, gradually tapering the picture into the background or surface. The print heads 105 may inject additional space between pixels to create the feathering, or may simply print only a portion of the pixels in the picture along the edges. As the distance from the center of the picture increases, the number of non-printed pixels may also increase to accentuate the feathering.

Attached to the conveyor 110 is a curing chamber 115. In the present embodiment, the holder 130 and surface enter the curing chamber through an opening 150 in one side of the chamber 1 15. In other words, the conveyor 110 extends into the chamber and permits the holder 130 to enter therein. It is not necessary for the chamber to seal shut or otherwise close around the holder, surface, or conveyor.

Once the holder 130 and surface enter the curing chamber 115, the processor 135 switches on the curing device housed in the chamber. In the present embodiment, the curing device takes the form of a high-energy light bulb (not shown) emitting relatively large quantities of ultraviolet light. Specifically, an approximately six hundred watt ultraviolet light bulb may be turned on when the surface is properly positioned within the curing chamber 115 (i.e., generally below the light). The ultraviolet light cures the ultraviolet inks deposited on the surface to form the picture in a relatively short time. In the present embodiment, such curing may take place within approximately one second. After the curing process, the inks used to form the picture are dry.

In alternate embodiments, ultraviolet lights of different wattages may be used. It should be noted, nevertheless, that a minimum wattage is required to cure the UV inks. Accordingly, substituting a weaker ultraviolet light will not simply increase the cure time, but instead will result in uncured inks. However, using a stronger ultraviolet light may decrease the curing time. Thus, in some embodiments, ultraviolet lights producing more wattage may be used to more quickly cure the inks, thus decreasing the overall print cycle time.

It should be noted that, in the present embodiment, the ultraviolet light (or other curing device) operates on standard 110 volt power. It should be further noted that all functions of the embodiment require only a 110 volt (or dedicated 30 amp) power source. Accordingly, the embodiment may be powered from any standard wall socket, electrical outlet, or power source, and does not require special wiring or heavy-duty power sources.

The present embodiment may print pictures on approximately two to three surfaces per minute, and may print on as many as six surfaces per minute. This print rate includes all time necessary to load surfaces into the holder 130, print pictures, and cure inks. Alternate embodiments may print on more or fewer surfaces per minute, and may print on more than one surface simultaneously (for example, by loading multiple surfaces into one or more holders spaced along the conveyor 110). Further, alternate embodiments may employ fewer print passes, and thus decrease the overall printing time.

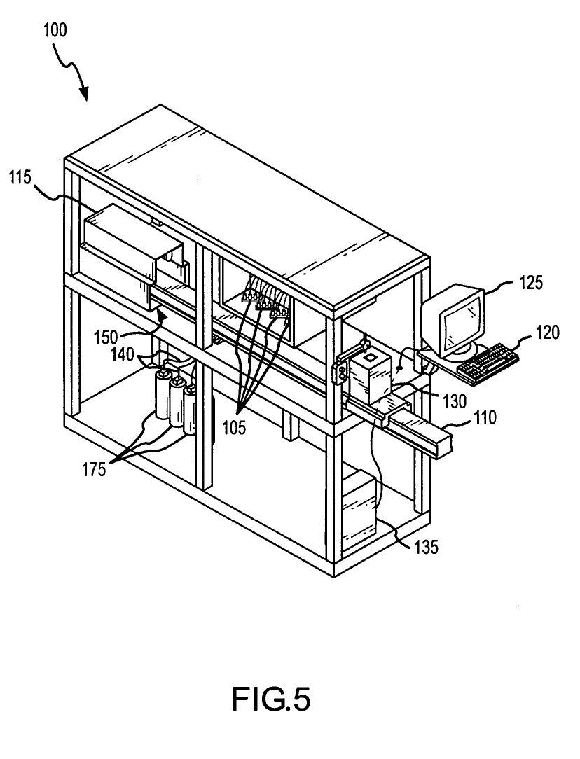

FIG. 5 depicts an isometric view of one embodiment of the invention 100, generally depicting the conveyor 110, holder 130, print heads 105, and curing chamber 115.

In another embodiment, the printing operation may take the form of a stand-alone operation, such as a kiosk. The kiosk may house the embodiment and permit a user to specify a picture for printing on a surface. The picture may be chosen from among a variety of pictures stored on a storage device (such as a magnetic or optical storage device, such as a CD-ROM, hard drive, Bernoulli drive, random access memory, and so forth) operably connected to the input device 120 and processor 135, or may permit a user to specify his or her own picture. For example, the user may provide a picture on any computer-readable medium, such as a CD-ROM or floppy disk. The medium may be inserted into an input device 120 (either the previously-mentioned input device or a second such device) or otherwise made accessible to the processor 135. Once accessible, the embodiment may retrieve the user picture for printing.

The kiosk embodiment may be located in a variety of places, such as malls, sporting arenas, airports, and so forth. A user may specify the picture to be printed, optionally specify or provide a printing surface, and optionally provide some form of payment (for example, by inserting cash into a bill or coin acceptor operably connected to the kiosk embodiment, providing a credit card or account number, or swiping or otherwise permitting the embodiment to read a magnetic or optical identifier such as a credit card strip). Once these conditions are met, the kiosk embodiment may print the picture on the surface as described elsewhere herein, and provide the printed surface to the user.

Alternately, an operator may control the operation of the kiosk embodiment, and may accept pictures directly from a third party desiring a custom-printed surface. In such a case, the kiosk embodiment operates substantially as described elsewhere herein.

Method of Operation

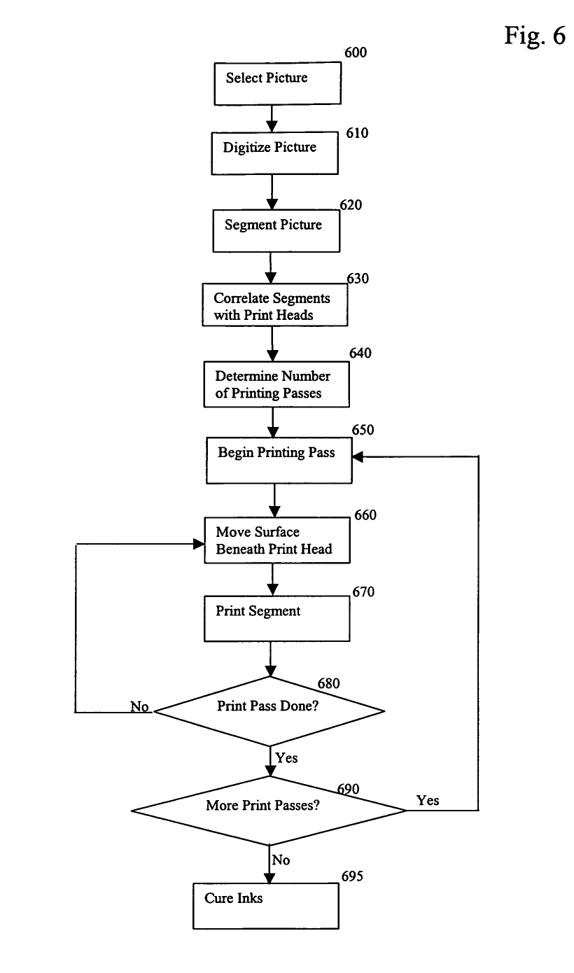

FIG. 6 is a flowchart depicting a method for printing a picture or graphic on a surface, in accordance with a first embodiment of the invention 100. In operation 600, a picture is selected for printing. In one embodiment, the picture is generally no larger than 1.6 by 2.25 inches or 504 pixels, although alternate embodiments may print pictures of larger or smaller dimensions. The selected picture may be drawn from a database or grouping of readily available, digitized pictures, or may alternately be any photograph or picture desired. For example, a user may supply his or her own photograph, drawing, painting, and so forth for eventual printing.

It should be noted that the embodiment may print a picture of greater circumference, width, length, or other measurements by either increasing the number of print heads 105, or by changing the offset angle of the print heads. For example, more print heads may be added either along the length or perpendicular to the rail 110 to increase either the maximum width or length (respectively) of a picture to be printed. Similarly, the angular offset of the print heads 105 may be varied to achieve such effects.

Further, pictures printed on curved or oblate surfaces may appear slightly larger than those on flat surfaces, even where the actual pixel width is identical. This is because the ink forming the pixel must travel further due to the surface's curvature, and thus may disperse further away from adjacent pixels. Additionally, as the pixels are laid on a curved surface, the curvature may slightly distort the otherwise flat mapping of the picture, with the result that pixels further from the center of the picture are spaced further apart than pixels nearer the center. Accordingly, one may increase the actual size of a printed picture by varying the curvature of the surface.

By contrast, flat surfaces generally do not distort pixels as described above, and so pictures printed on flat surfaces may appear to have better resolution. Thus, one may create a sharper picture by printing on a flat surface.

In operation 610, the selected picture is digitized, if necessary. Various methods of digitization are known to those skilled in the art. For example, the picture may be scanned on a flatbed scanner and converted into a computer graphics file format, such as a joint photographic experts group (JPEG) format, a tagged image file format (TIFF), a graphics interchange format (GIF), a bitmap format (BMP), and so forth. If the picture is selected from a group of computer images, this step may not be required. Further, the picture may be modified with any of a variety of commercially-available software packages (such as ADOBE PHOTOSHOP, COREL DRAW, and so forth) to add effects thereto, such as the aforementioned feathering or black border.

Once digitized, in operation 620 the picture may be divided into a series of segments, each approximately equal in dimension. In the present embodiment, the picture is divided into four segments, each of equal length. Each picture segment is generally no larger than 1.6 by 2.25 inches, or 504 to 700 pixels, in width and length, respectively. In the present embodiment, each head has 126 separate nozzles, each of which deposits a separate pixel on the surface. Since four print heads 105 are used in the embodiment, the maximum print width is 4×126, or 504, pixels.

Alternate embodiments may divide a picture into larger or smaller segments, may use more or fewer segments, or may not segment the picture at all.

Generally, the embodiment segments the picture to account for the overall dimensions of the print heads 105. As the surface passes beneath each print head in a substantially continuous manner without stopping or pausing, the print head 105 must deposit ink in the shape of the picture on the surface in a relatively short period of time. Thus, the firing of the print heads 105 is finely sequenced. The embodiment typically segments the picture into a number of sections equal to the total number of print heads.

In operation 630, each of the various picture segments is correlated or otherwise assigned to a specific print head 105. As part of this operation, the data comprising the picture segment is transmitted by the processor 135 (typically from a local memory or other storage device, such as a magnetic or optical storage device) to the print head 105.

Typically, because the present embodiment moves the surface beneath the set of print heads 105 in a single, continuous motion (or pass) without pausing and the left surface edge leading in the printing pass, the first print head prints the rightmost section or segment of the picture, the second prints the section immediately to the left of the rightmost section, and so forth, until all sections comprising the picture have been printed. In alternate embodiments, the printing order of these sections may be reversed, staggered, random, or any other order conceivable.

The use of wider print heads 105 (for example) may permit the embodiment to employ fewer segments. Alternately, the embodiment may employ fewer heads and pause the surface beneath one or more print heads to ink larger portions of the picture. For example, in a two print head 105 embodiment, the picture may be segmented into two sections, and each print head may print half of the picture. In yet other embodiments, the segments may be of differing sizes, such that each segment is not exactly equal in width, length, or other segmented dimension to every other segment.

In operation 640, the number of printing passes required to print the picture is determined. As previously mentioned, the embodiment may print a picture in one or more passes, and one or more color inks may be deposited in each pass. Typically, more printing passes yields a sharper, clearer image. However, increasing the number of printing passes above the number of separate inks (i.e., different colors of inks) available generally will not increase the image clarity. Accordingly, in an embodiment having (for example) four different colored inks, four or more printing passes generally yields a clearer image than printing in a single pass. Thus, in this operation, one or more colors may be assigned to each print pass, and only the assigned color inks will be deposited by the print heads 105 on the appropriate pass.

In operation 650, the first printing pass begins. The printing pass may be initiated, for example, by an operator input through the input device 120. The input may signal the processor 135 to begin the pass.

The holder 130 and surface move along the conveyor 110 until stationed beneath one of the print heads 105, as shown in operation 660. As previously mentioned, the holder and surface may travel the length of the conveyor while the conveyor itself (or at least a portion thereof) remain stationary, as in the case of a rail system, or the conveyor 110 may move with the holder 130 and surface, as in the case of a belt system.

Once the surface is properly positioned beneath the print head 105, in operation 670 the print head 105 deposits ink to print at least one color of its assigned picture segment. Depending on the number of printing passes assigned in operation 640, multiple inks may be deposited by the print head during this operation.

In operation 680, the processor 135 determines whether the print pass is complete. Generally speaking, a print pass is completed when all print heads 105 have deposited ink to form their assigned segments. In other words, the print pass completes when the entire picture is formed on the surface in the color or colors assigned to the print pass. If the print pass is complete (that is, if all print heads have printed their segment in the appropriate color), operation 690 is executed. Otherwise, the embodiment executes operation 660 again, incrementally moving the holder 130 and surface until the surface rests beneath the next print head 105 in the print pass.

In operation 690, the embodiment determines whether more print passes are required, or whether the number of printing passes specified in operation 640 has been reached. If additional print passes are required, operation 650 is executed again and the next print pass begins. Otherwise, the embodiment executes operation 695.

In operation 695, the holder 130 and associated surface enter the curing chamber 115, the curing device is activated, and the inks forming the picture are cured. Curing is generally discussed above. Once the inks cure, the printing process is complete.

Software Data Flow

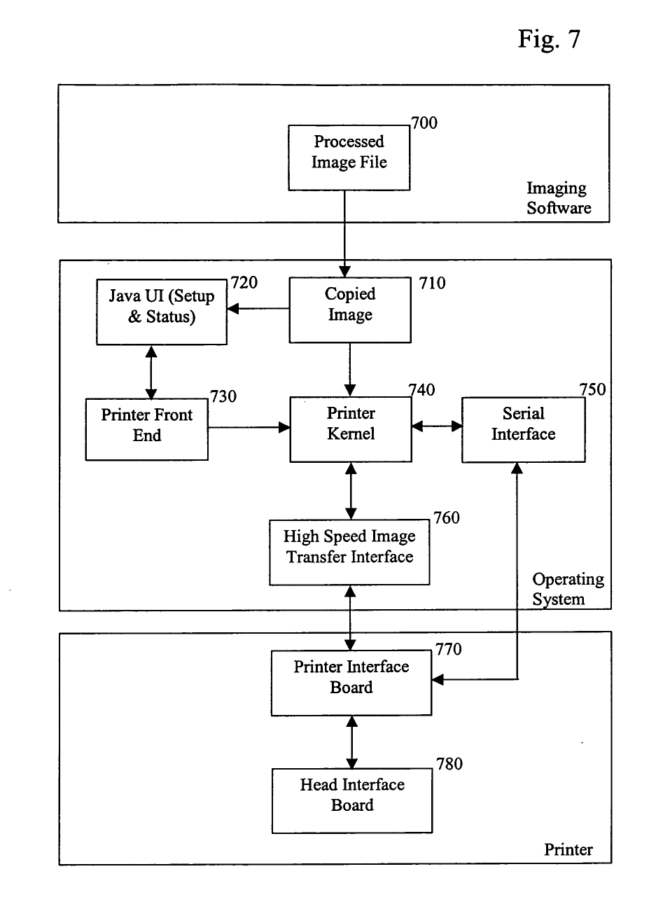

FIG. 7 depicts a software data flow diagram, generally displaying the flow of data through the embodiment. Initially, an image file is processed by imaging software to create a processed image file, as shown in state 700. The processed image file, for example, may be a digitized scan of a picture or any other computer-readable file or format corresponding to a picture.

The processed image file is typically copied into a memory or other file storage location (such as the aforementioned magnetic or optical storage devices), creating a copied image. This copied image may be accessed by the processor 135 through an operating system, as shown by state 710. The processor, in turn, may present the copied image to an operator through a user interface (“UI”), typified by state 720. The UI, for example, may be implemented as a Java applet, and may be responsible for coordinating presentation, setup, and status of the image to and with the operator. The UI may also coordinate and/or accept inputs from the input device 120. For example, the operator may use the UI (possibly in combination with the input device) to select a picture for printing (again, possibly the copied image), specify the number of copies to print, specify the number of print passes to be used during each printing operation, and so forth.

In state 730, information specified by the operator through use of the UI is transmitted to a printer front end. Generally, the printer front end acts to control the operation of the printer 100, and is an interface between the user interface and one or more print heads 105. The printer front end, for example, may segment pictures as described above, store and/or transmit picture segments to each print head, instruct the print head regarding the number of print passes and/or the corresponding inks to be used in each print pass, and so forth. The printer front end may be implemented as a software module or a hardware component, and may access a storage device (for example, a memory, magnetic storage, or optical storage) to at least temporarily hold the aforementioned information.

In state 740, the image is generally processed by a printer kernel. The printer kernel typically accepts data from both the printer front end and copied image, and may use the printer front end data to operate on the copied image. For example, the printer kernel may segment the image (if the printer front end does not), and determine exactly what print head 105 operations are necessary to print the image.

Data is generally transmitted from the printer kernel to a printer interface board, or “PIB.” This data may be transmitted through a serial interface, as in state 750, a high-speed interface, as in state 760, or a combination of the two. Generally, such interfaces at least partially take the form of hardware, such as an interface board.

Regardless of how the data is transmitted, it is generally received by the PIB. The data is processed by the PIB, as shown in state 770, to determine print logic, pump and valve interface logic, and so forth. For example, the PIB generally controls the firing and operation of the print heads 105, as well as the operation of the pumps and primers. The PIB may also segment the image, if it is not segmented prior to being received by the PIB. If necessary or desirable, the PIB may perform further operations on the picture, such as changing color balance, converting the picture to greyscale, compressing the picture, reformatting the picture (for example as a JPEG, BMP, or TIFF, regardless of the input format), and so forth.

Specific instructions for each print head 105 (presuming the embodiment has more than one) are transmitted from the PIB to a head interface board (“HIB”), which implements the instructions for the print head in state 780. Each print head is controlled by a dedicated HIB in the present embodiment, although alternate embodiments may employ more or fewer HIBs per print head. Generally, the HIB operates to control its corresponding print head 105, for example controlling the printing sequence and timing of the head. The HIB may also control the pump supplying ink to the head. Further, each HIB operates a heater attached to the print head.

The heater typically maintains a constant print head temperature. Generally, if the head 105 (and thus the ink) becomes too cool, the ultraviolet ink may streak and run, which in turn creates a smeared picture. Similarly, if the head and ink become too hot, the ink may blob or pool on the surface, again distorting the picture. In the present embodiment, the heater maintains a temperature of approximately thirty-seven to fifty-seven degrees Celsius (100-135 degrees Fahrenheit). Alternate embodiments may employ heads having internal heaters (such as the SPECTRA print heads previously mentioned), or may employ print heads 105 and/or inks that may operate acceptably at room temperature.

Network Applications

The embodiments described herein may also advantageously operate at least partially across a network, such as the Internet, an intranet, a wide area network (WAN), a local area network (LAN), wireless network (including, for example, infrared and radio networks), and so forth. Generally, a picture interface may be presented to a user, and may facilitate selection of a picture by the user. The picture interface, for example, may take the form of a website, hypertext markup language (HTML) document, exchange markup language (XML) document, and so forth (collectively, “document”), any of which may either display pictures or text describing pictures.

The user may select the picture from the document, or may provide a picture of his or her own. For example, the user may scan or otherwise digitize a picture, and submit it to the embodiment through a mechanism provided in the document (such as a dialog box). Alternately, the user may transmit a message (such as electronic mail) to the embodiment containing the picture, or with the picture attached thereto.

Regardless of the method of transmission across the network, once the embodiment receives the picture, it may print it onto a surface as described above. Optionally, the user may also specify a surface for printing through any of the methods described herein, and may specify the surface when providing or selecting the picture.

A document operative to allow a user to select or provide a picture may also contain payment mechanisms (such as means to provide a credit card or other account number), a manner for specifying a quantity of surfaces, a manner for providing a shipping address, and so forth. Such mechanisms and manners may include the aforementioned dialog boxes, selection from one or more lists, electronic exchange of messages or other information, and so forth.

The X-Y Embodiment

As described herein, the embodiment typically employs a holder and conveyor system permitting the conveyor to move only along the length of the conveyor (i.e., in an “X” direction). An alternate embodiment may permit the holder 130 to move along the length of the conveyor 110, while the print heads 105 move perpendicularly to the length of the conveyor (i.e., in a “Y” direction). This embodiment is colloquially referred to as the “X-Y embodiment” herein.

The X-Y embodiment segments pictures not only laterally, as shown in FIG. 3, but also vertically. Effectively, the picture is segmented into a series of squares, with each segment comprising a set of squares stacked vertically atop one another. In this embodiment, the holder 130 and surface move along the conveyor until located beneath the print heads 105. Each print head deposits ink to form a single square, then moves along the Y-axis. Once the print heads are repositioned, they deposit ink to form a second series of squares, one in each segment. Generally, each second square is located either at least partially above or below the first square printed by the print head, and may partially overlap the corresponding first square. Alternately, each second square may be adjacent to the corresponding first square, with no overlap. Where overlap occurs, the offset between squares-may be any distance desired, for example one pixel.

This process continues until all squares have been printed. In one exemplary embodiment, eight separate Y-axis passes may be made by the print heads 105, although alternate embodiments may employ more or fewer passes.

The process may also be combined with multiple color passes in the X direction, as described above. In other words, during the movement along the Y-axis, each print head 105 may print only a single color in each square. The print heads may then reset to their original position, and a second set of colors may be printed in each square. This may continue until all colors are printed.

Alternate embodiments may permit the holder 130 to move in both the X and Y directions, may permit the heads 105 to move in both the X and Y directions, or may permit the print heads to move in the X direction and the holder to move in the Y direction. Similarly, alternate embodiments of any embodiment described herein may permit any motion of the holder 130 and/or conveyor 110 to be replaced by corresponding motion of one or more print heads 105. For example, with respect to the single axis of motion embodiments described above, the print heads may move while the holder remains stationary during the printing process. As yet another option, the holder 130 may move under the print heads 105, at which point the print heads may move across the surface to print the desired picture. Essentially, any combination of movement between the print heads and holder is embraced by various embodiments of the present invention.

Variable Pixel Embodiment

In another embodiment, the print heads 105 may be configured to deposit ink pixels of varying size at different points on the surface. The pixels, for example, may be finer towards the edges of a picture or segment, and larger towards the middle of a picture or segment. Pixel sizes or ink droplet sizes may vary between nozzles in the same print head 105, or may vary from print head to print head. For example, the print heads manufactured by SPECTRA and previously mentioned herein may permit such control of pixel sizes.

By changing the pixel size, apparent resolution (i.e., clarity of the image) may be enhanced. Since the ink droplet used to form each pixel typically expands in diameter as it travels, and ink droplets must travel further to impact the outer edge or circumference of a curved surface, pixels formed on the outer circumference of a curved surface tend to be slightly larger than those towards the middle of the surface. Accordingly, the ink droplet size may be made smaller or finer for pixels located toward the outer edge of a picture or outer circumference of a curved surface to account for the additional spreading the ink droplet undergoes in comparison to ink droplets used to form pixels near the center of a picture. The ink droplet size (or the absolute pixel size, presuming all pixels are printed on a flat surface) may be calibrated to take such expansion into effect, thus creating uniformly-sized pixels on a curved surface.

Conclusion

As will be recognized by those skilled in the art from the foregoing description of example embodiments of the invention, numerous variations on the described embodiments may be made without departing from the spirit and scope of the invention. For example, various inks may be used, as may different curing devices (for example, a heat lamp), or pictures may be segmented in different ways (or not segmented at all). Further, while the present invention has been described in the context of specific embodiments and processes, such descriptions are by way of example and not limitation. Accordingly, the proper scope of the present invention is specified by the following claims and not by the preceding examples.

I claim:

1. A method for printing on a surface, comprising:
providing a digital picture;
providing at least one ultraviolet ink;
depositing the ultraviolet ink on the surface to form a printed picture corresponding to the digital picture; and
curing the ultraviolet ink.

2. The method of claim 1, further comprising:
segmenting the digital picture into at least a first and second segment;
transmitting the first segment to a first print head;
transmitting the second segment to the second print head;
by means of the first print head, depositing the ultraviolet ink on the surface to form a first printed segment corresponding to the first segment; and
by means of the second print head, depositing the ultraviolet ink on the surface to form a second printed segment corresponding to the second segment.

3. The method of claim 2, wherein:
the first and second segments are adjacent portions of the picture; and
the first and second printed segments are aligned in the same manner as the first and second segments.

4. The method of claim 1, further comprising depositing the ultraviolet ink on the surface to form a border around the printed picture.

5. The method of claim 4, wherein the border obscures at least a portion of the printed picture.

6. The method of claim 2, further comprising:
creating a border around the digital picture; and wherein
the step of segmenting the digital picture into at least a first and second segment further comprises segmenting the border into at least a first and second border segment, the first border segment obscuring a portion of the first segment and the second border segment obscuring a portion of the second segment.

7. The method of claim 6, wherein:
the step of by means of the first print head, depositing the ultraviolet ink on the surface to form a first printed segment corresponding to the first segment further comprises depositing the ultraviolet ink on the surface to form a first printed border corresponding to the first border segment; and
the step of by means of the second print head, depositing the ultraviolet ink on the surface to form a second printed segment corresponding to the second segment further comprises depositing the ultraviolet ink on the surface to form a second printed border corresponding to the second border segment.

8. The method of claim 1, further comprising feathering the edges of the digital picture.

9. The method of claim 1, wherein the surface is one of curved, oblate, or cylindrical.

10. The method of claim 1, further comprising depositing the ultraviolet ink on the surface to form the printed picture within a border pre-printed on the surface.

11. The method of claim 1, wherein the surface is a sports-related object.

12. A method for printing on a surface, comprising:
placing the surface in a holder;
moving the holder in a first direction to stop beneath at least one print head;
depositing an ultraviolet ink from the at least one print head on the surface to form at least a portion of a picture;
moving the at least one print head; and
depositing the ultraviolet ink from the at least one print head on the surface to form at least a second portion of a picture;
wherein the surface is a non-flat, sports-related object.

13. The method of claim 12, further comprising:
in response to depositing the ultraviolet ink from the at least one print head on the surface to form at least a second portion of a picture, moving the holder into a curing chamber; and
curing the ultraviolet ink in the curing chamber.

14. The method of claim 13, wherein the step of moving the holder in a first direction to stop beneath at least one print head comprises moving the holder along a conveyor to a first point; and
the step of moving the holder into a curing chamber comprises moving the holder along the conveyor to a second point, the second point within the curing chamber.

15. The method of claim 12, wherein the step of moving the at least one print head comprises moving the at least one print head in a second direction perpendicularly to the first direction.

16. The method of claim 15, wherein the at least a second portion of the picture is adjacent to the at least a first portion of a picture.

17. The method of claim 15, wherein the at least a second portion of the picture at least partially overlaps the at least a first portion of a picture; and
the at least a second portion of the picture is offset from the at least a first portion of a picture by an offset distance.

18. The method of claim 17, wherein the offset distance is one pixel.

19. A method for printing a picture on a surface, comprising:
A method for printing on a surface, comprising:
providing a digital picture;
providing at least one ink;
depositing the ink on the surface in a plurality of ink droplets, each of the plurality of ink droplets corresponding to one of a plurality of pixels, the plurality of pixels forming a printed picture corresponding to the digital picture; and
curing the ink; wherein
at least a first ink droplet of the plurality of ink droplets is of a first size; and
at least a second ink droplet of the plurality of ink droplets is of a second size.

20. The method of claim 19, wherein:
the surface is curved;
the first ink droplet forms a first pixel located a first distance along the curvature of the surface from a point corresponding to the center of the printed picture;
the second ink droplet forms a second pixel located a second distance along the curvature of the surface from the point corresponding to the center of the printed picture; and
the first size is smaller than the second size.
